(19) United States
(12) Patent Application Publication
(10) Pub. No.: US 2011/0011277 A1
(43) Pub. Date: Jan. 20, 2011

(54) Slider grilling appliance

(76) Inventor: Gregg Bond, Beverly Hills, CA (US)

Correspondence Address: Gregg Bond, 313 El Camino Drive, Beverly Hills, CA, 90212, US

(21) Appl. No.: 12/460,313

(22) Filed: Jul. 17, 2009

(51) Int. Cl. A47J 37/06

(52) U.S. Cl. 99/375; 99/382

(57) ABSTRACT

A portable electric slider burger grilling appliance with an upper housing containing an upper grilling plate and a lower housing containing a lower grilling plate. The upper grilling plate includes a plurality of depressions that are each the size of a slider type burger. The lower grilling plate includes raised burger platforms that correspond to the location of the depressions in the upper grilling plate. The upper housing and lower housing are hinged together. The bottom grilling plate is angled slightly downward and has a drain aperture on the downward side so that grease can travel through channels in the plate and exit the plate through the aperture to a grease receiving tray located under the grill plate. A custom spatula is provided and has a slider burger forming depression on one end and a spatula portion on the opposite end.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of cooking appliances and more specifically to a slider grilling appliance.

Cooking appliances of the kind which the present invention is concerned normally consist of a pair of plates suitably mounted which can be brought together in a substantially parallel relationship with the food to be cooked between them. Portable electric grilling appliances such as the device invented by John McClean, in his patent U.S. Pat. No. 4,150,609, issued in April of 1979, discloses such an apparatus. His device consists of a hinged top and bottom heating element, each embedded in a block of metal. The heating plates are flat and are meant for grilling steaks, hamburgers and other foodstuffs. Martin Brady, in his patent U.S. Pat. No. 6,889,602 discloses a portable electric grilling appliance that includes heated metal plates that each have a molded in pattern that can receive batter and creates a standard waffle when the batter is heated and cooked between the heated plates.

The metal plates are usually constructed of cast aluminum and have a non stick coating applied to the side that is in contact with the food to be cooked.

However, there is a deficiency in the prior technology in that none of the previous designs was created specifically for cooking slider type burgers. A slider type burger is a small diameter hamburger and is typically approximately two inches in diameter and one half of one inch thick. None of the prior designs allows a person to perfectly locate a plurality of slider sized burgers on raised platforms located on the bottom plate so that they can be molded and cooked by a mating depressions on a top plate. Additionally, no other appliance shown in the prior art has a configuration allows the cooked slider sized burgers to be positioned in an unencumbered manner on the bottom plate upon opening the appliance so that they can be easily removed with a standard spatula.

### BRIEF SUMMARY OF THE INVENTION

The primary object of the invention is to provide an electric grilling appliance that includes a grill plate that contains a plurality of slider burger sized depressions so that the appliance can cook a plurality of slider type burgers.

Another object of the invention is to provide a slider grilling appliance that allows excess grease to drain away from the cooking burgers and into a collection tray.

Another object of the invention is to provide a slider grilling appliance that includes a custom spatula device that allows the user to construct perfectly sized burger patties as well as to remove cooked burgers.

A further object of the invention is to provide a slider grilling appliance whose cooking surface includes a plurality of raised bars that cause the cooked burger to have the appearance of a burger cooked on an outdoor caracole grill.

Another object of the invention is to provide a slider grilling appliance that causes the cooked slider burgers, upon opening the appliance, to be deposited on a substantially flat grill plate base so that they can be easily removed by the user with a spatula tool.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed slider grilling appliance comprising: an upper housing, a lower housing, a housing hinge member, an upper grilling plate, a lower grilling plate, an upper heating element, a lower heating element, a standard thermostat, a grease receiving tray, a power cord and plug, said upper heating element fixedly attached to the top portion of said said upper grilling plate, said lower heating element fixedly attached to the under portion of said lower grilling plate, said upper housing surrounding said upper heating element, said lower housing surrounding said lower heating element, said power cord connected at one end to said heating elements and at the opposite end to said plug, said thermostat fixedly attached to one said grilling plate to control the temperature of said heating elements, said housing hinge member connecting said upper housing to said lower housing, said upper grilling plate forming the bottom surface of said upper housing, said lower grilling plate forming the top surface of said lower housing, said upper grilling plate including a plurality of slider burger sized depressions, said lower grilling plate including a plurality of raised slider burger placement disks that correspond to the location of said upper grilling plate burger depressions, said lower grilling plate angled with regard to the ground plane said lower grilling plate including grease carrying channels, said lower grilling plate including at least one drain aperture, and said grease receiving tray slidably retained under said lower grilling plate and capable of retaining said grease that drips down from said lower grilling plate drain aperture.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a plan view of the upper grilling plate.

FIG. 3 is a side section view of the upper grilling plate.

FIG. 4 is a plan view of the lower grilling plate.

FIG. 5 is a first section view of the lower grilling plate

FIG. 6 is a second section view of the lower grilling plate.

FIG. 7 is a third section view of the lower grilling plate.

FIG. 8 is a side view of the invention.

FIG. 9 is a top view of the invention.

FIG. 10 is a front view of the invention.

FIG. 11 is a rear view of the invention.

FIG. 12 is a bottom view of the invention.

FIG. 13 is a perspective view of the spatula tool of the present invention.

FIG. 14 is a side view of the spatula tool of the present invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

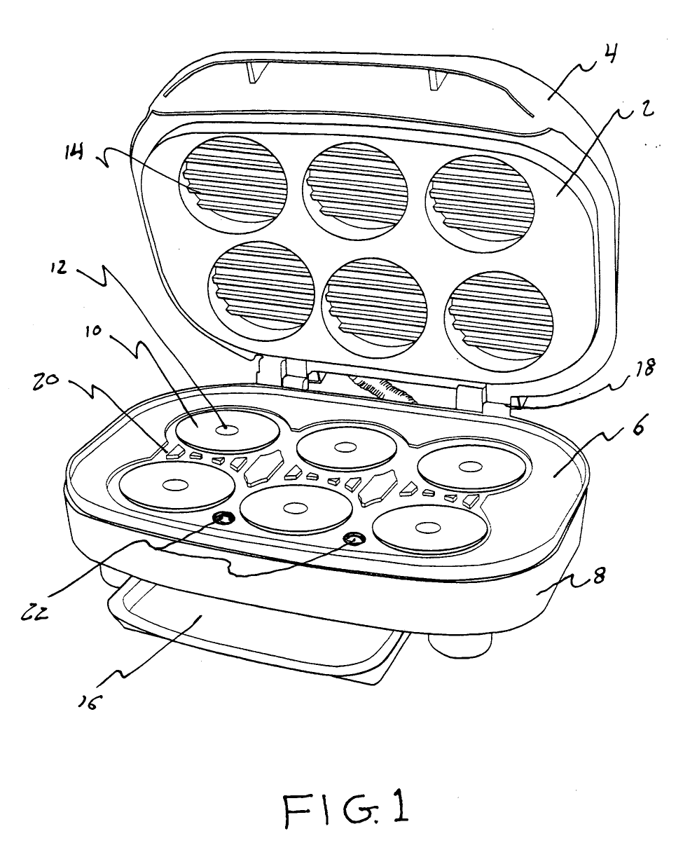

Referring now to FIG. 1 we see a perspective view of the invention in the open position. The invention is a portable, plug in electric cooking device designed for household use. An upper housing 4 is constructed of high temperature plastic. A metal heating grill plate 2 encloses the lower portion of housing 4 and includes a plurality of depressions 14 that are the size and shape of a standard slider type burger which is approximately two inches in diameter and one half of an inch thick. These burgers are intentionally smaller than a standard burger and have become a popular food item in recent years. A lower housing 8 is constructed of high temperature plastic. Metal heating grill plate 6 encloses the upper portion of housing 8 and includes a plurality of burger platforms 10 that correspond with and align with the depressions 4 in upper plate 2 when the two plates are in the closed position they are substantially parallel to each other. Because the grill plates 6, 2 are not both flat, as in other grilling appliances, the slider burgers can not be over pressed accidentally. Over pressing can cause a thin or deformed slider burger. The depressed areas 20 around the burger platforms 10 allow excess grease to flow to drain apertures 22 so that the excess grease can be retained by tray 16 which normally resides under plate 6 but is shown here in its partially withdrawn position. Plate 6 is slightly tilted so that the forward most portion of the plate is lower than the rear portion of the plate thereby allowing gravity to cause liquefied grease to travel to drain apertures 22. The upper housing 4 and the lower housing 8 are attached by hinge members 18. Standard heating elements, not shown, are each fixedly attached to the top side of upper plate 2 and the underside of lower plate 6 and are enclosed by housings 4, 8. The heating elements are controlled by a standard thermostat, not shown, which is attached to the upper surface of upper heating plate 2. The heating grill plates 2, 6 are preferably constructed of die cast aluminum and coated with a standard non-stick coating. It should be noted that other materials may be used for construction of the appliance. Additionally, food items other than slider burgers may be cooked in the appliance of the present invention.

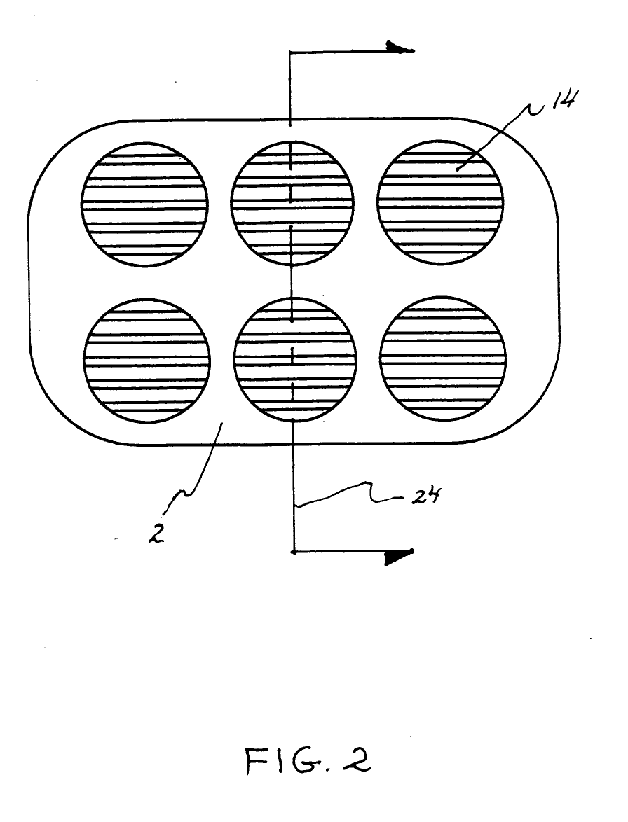

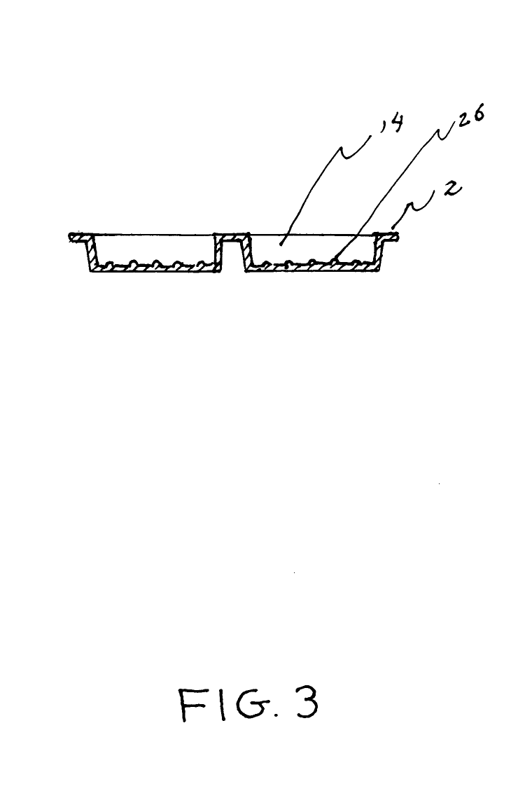

FIG. 2 shows a plan view of upper heating plate 2. In the preferred embodiment, six equally spaced slider burger depressions 14 are shown. FIG. 3 shows a section view of plate 2 as defined by section line 24 shown in FIG. 2. The section view shows raised bars 26 at the base of slider burger depressions 14. These bars 26 form grill lines in the cooked slider burger that give the burger grill lines similar in appearance to that of a burger cooked on a standard outdoor grill.

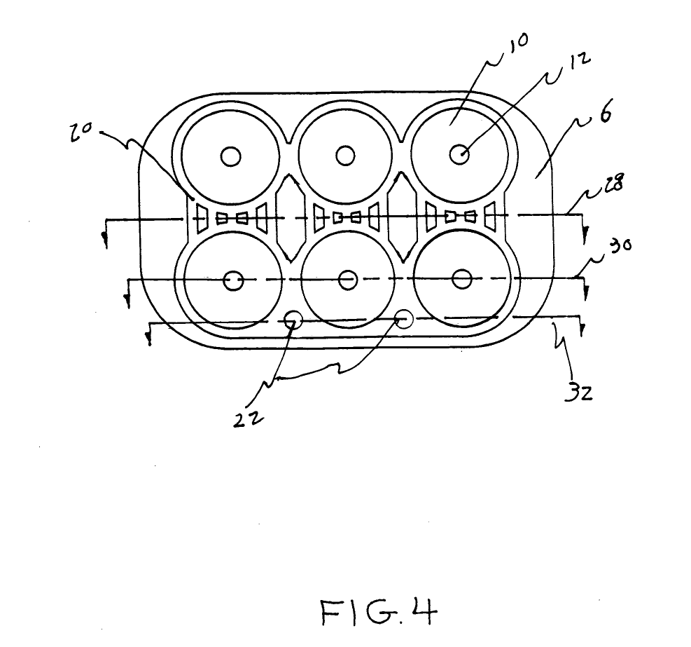

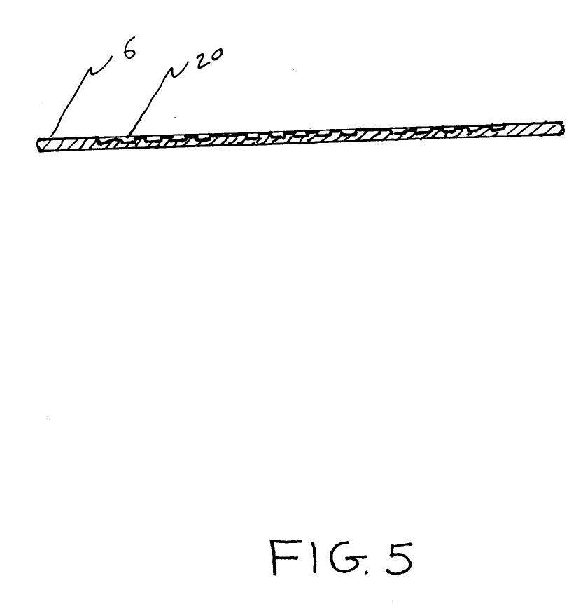

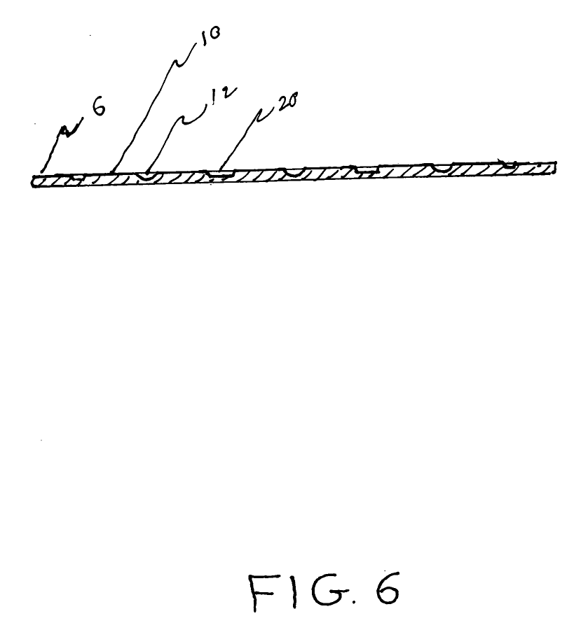

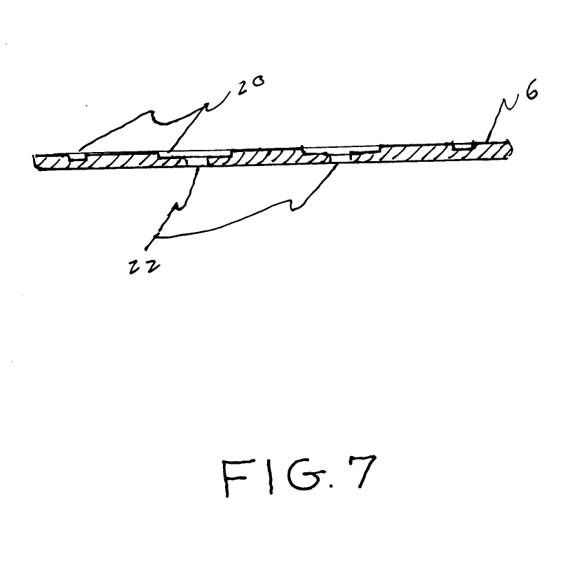

FIG. 4 shows a plan view of lower heat plate 6 The six slider burger platforms 10 correspond in location to the burger depressions 14 in upper plate 2. A centrally located depression 12 in each burger platform 10 as well as the circular visual cue produced by the raised platform 10 helps the user correctly place the uncooked burger onto lower platform 6 so that when the user lowers the upper heat plate 2, the uncooked slider burgers will align with and make their way into burger depressions 14. FIG. 5 is a section view of the lower heat plate 6 as defined by section line 28 shown in FIG. 4. This sectioned view shows the depressed canals 20 that allow liquefied grease to travel to drain apertures 22. FIG. 6 is a section view as defined by section line 30 and shows the central depressions 12 in burger platforms 10 as well as grease canal portions 20. The central depressions 12 also help keep the burger fixed in the desired position because a portion of the uncooked burger can fill the depression 12 and help anchor it in position until upper plate 2 is closed down upon the lower plate 6. FIG. 7 shows a section view of the lower plate 6 as defined by section line 32. This section view shows drain apertures 22 as well as grease canals 20. When slider burgers are finished cooking within the present invention the user opens the hinged upper housing 4 and attached upper grill plate 2 causing the cooked burgers to remain on lower heating plate 6. In this way, the cooked burgers can be easily removed from plate 2 by using a standard spatula because the burgers are unencumbered by the side walls of burger forming depressions 14.

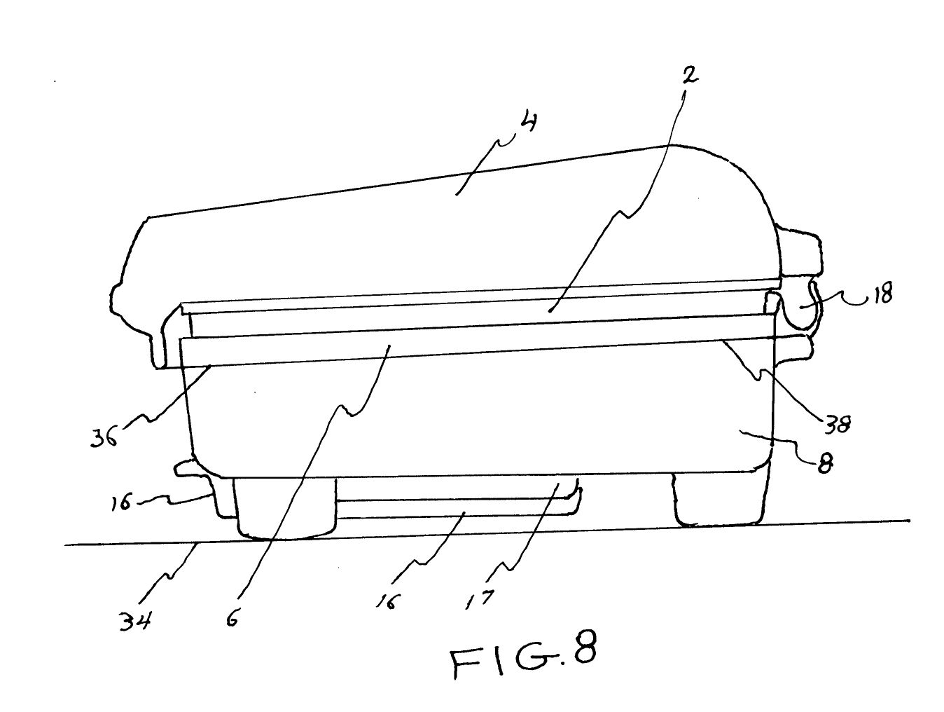

FIG. 8 is a side view of the invention. In this view it can be seen that the rear portion 38 of lower heat plate 6 is slightly higher than the front portion 36 of lower heat plate 6 with respect to horizontal ground plane 34. This configuration allows gravity to cause the liquefied grease to travel to drain apertures 22. Hinge member 18 can be clearly seen, as well as grease retaining tray 16 which is slidably held in place by retaining rail 17.

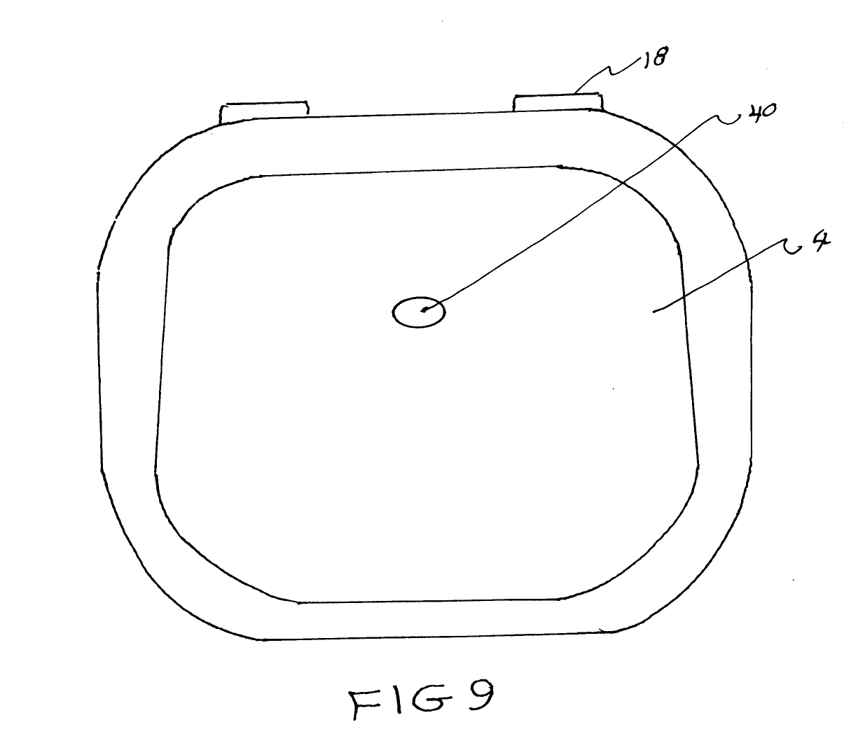

FIG. 9 shows a top plan view of the invention. Upper housing 4 includes an LED light 40 that lets the user know that the unit is plugged in and in heating mode. Hinge members 18 can also be seen.

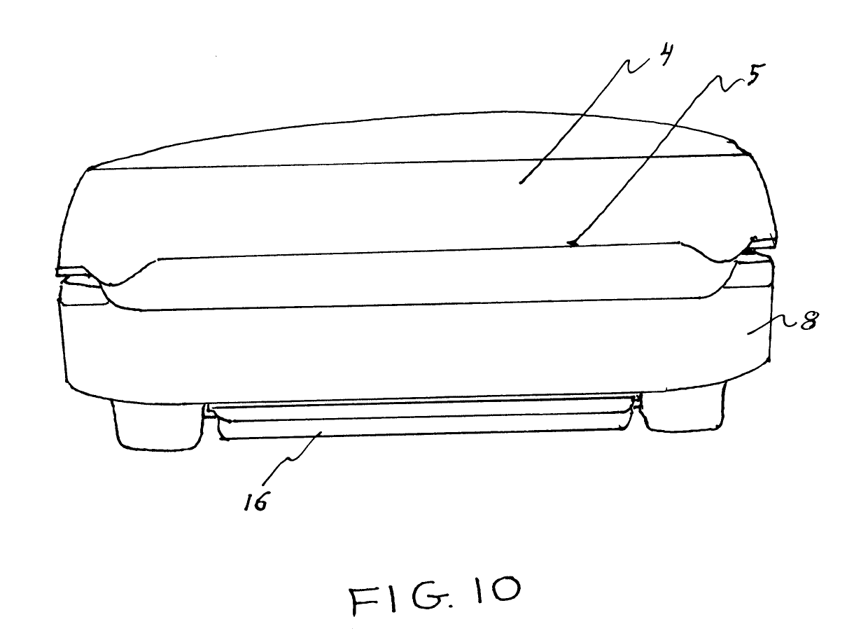

FIG. 10 is a front view of the invention. The front most part 5 of housing 4 protrudes as a ledge and acts as a handle to allow the user to lift the upper housing 4 during use. The front of grease retaining tray 16 can be seen.

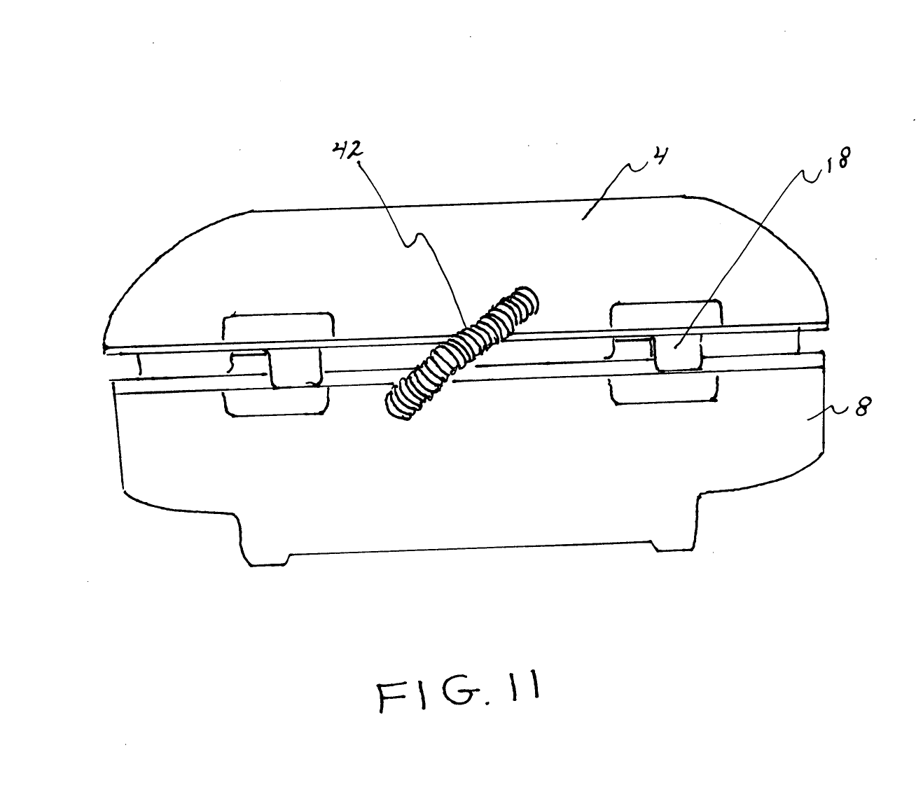

FIG. 11 shows a rear view of the invention spring metal coil 42 retains a standard electric power cable that carries electricity to the upper heating element. Hinge members 18 can be clearly seen.

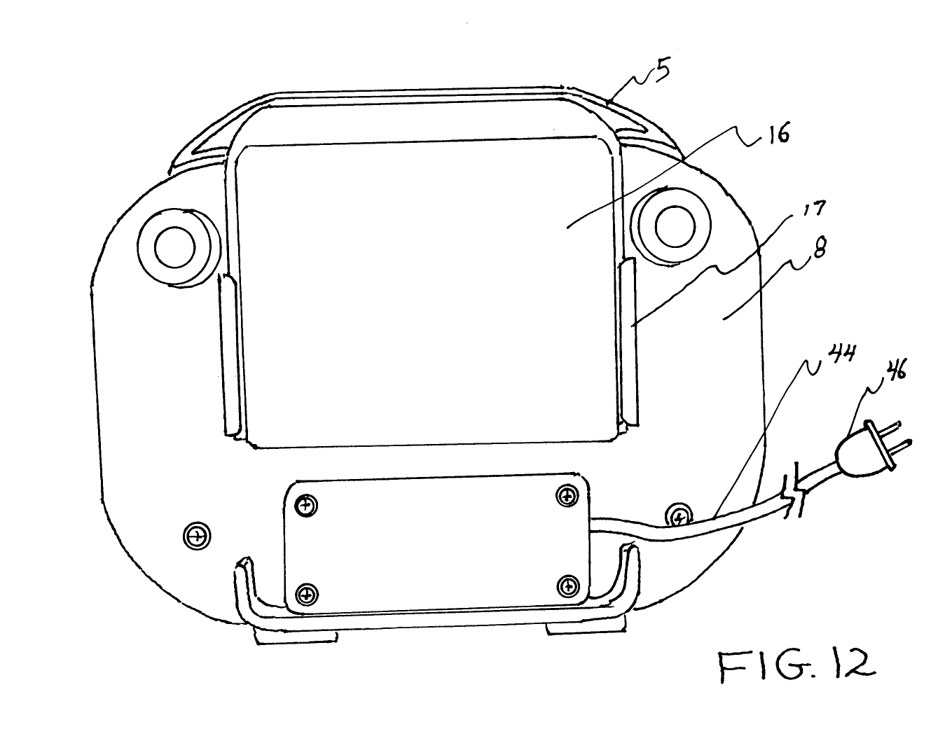

FIG. 12 shows a bottom view of the invention. Ledge 5 can be seen as the front portion of upper housing 4 as described above in the discussion of FIG. 10. Grease retaining tray 16 can be clearly seen as retained by retaining rails 17. Standard power cord 44 and attached standard 46 plug provide standard 110 Volt AC house voltage to the invention.

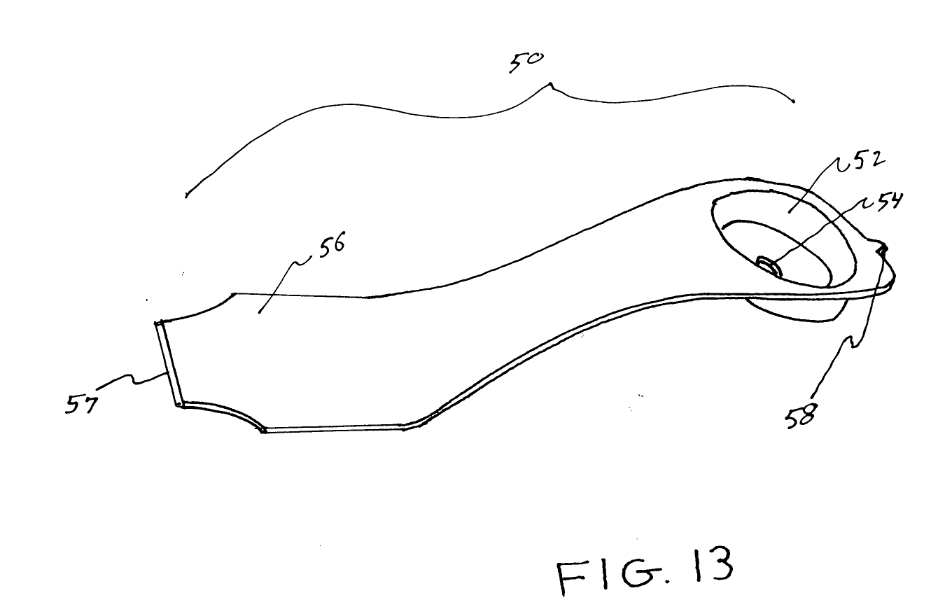

FIG. 13 shows a perspective view of a custom tool 50 that is molded from rigid high temperature plastic such as nylon. One end of the tool 50 includes a depressed portion 52 that is the exact size of a slider burger as described above. The user can place a portioned amount of uncooked burger material into the depression 52 to form it to a slider burger shape and then can eject the burger by inserting a finger or other rod type item into the rear of aperture 54 and pushing the burger out of the depression 52. An integral tab 58 protruding from the end of the tool 50 can be used to clean the canal surfaces 20 of the lower plate 2 as well as the surfaces between the rails in burger depressions 14 located on upper heating plate 6. The opposite side of tool 50 is a spatula that can be used by the user to slide under the cooked burgers to remove them from lower plate 2.

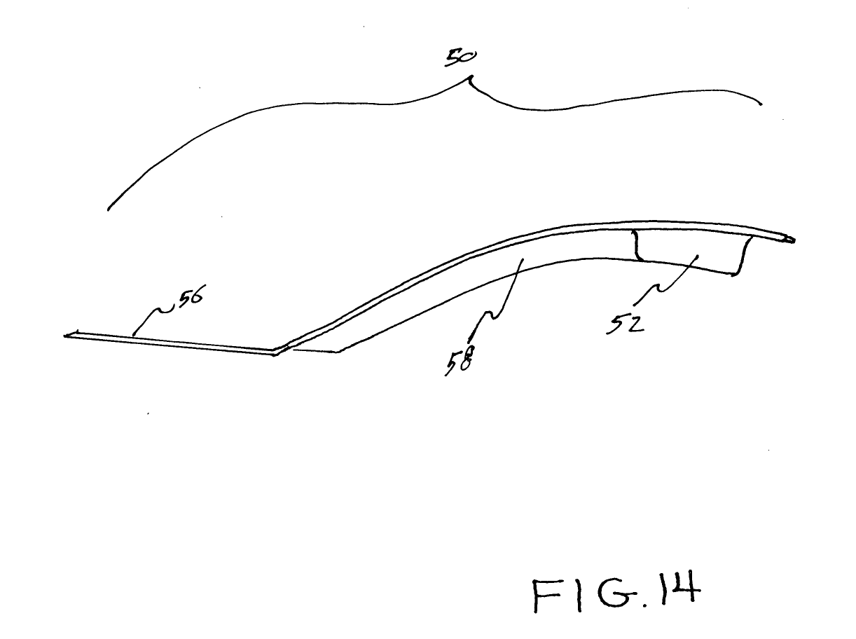

FIG. 14 shows a side view of tool 50 showing the general spatula shape of the tool. Rib 58 helps strengthen and rigidize the shaft portion of the tool 50.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. slider grilling appliance comprising:
an upper housing;
a lower housing;
a housing hinge member;
an upper grilling heat plate;
a lower grilling heat plate;
an upper heating element;
a lower heating element;
a standard thermostat;
a grease receiving tray;
a power cord and plug;
said upper heating element fixedly attached to the top portion of said said upper grilling plate;
said lower heating element fixedly attached to the under portion of said lower grilling plate;
said upper housing surrounding said upper heating element;
said lower housing surrounding said lower heating element;
said power cord connected at one end to said heating elements and at the opposite end to said plug;
said thermostat fixedly attached to one said grilling plate to control the temperature of said heating elements;
said housing hinge member connecting said upper housing to said lower housing;
said upper grilling plate forming the bottom surface of said upper housing;
said lower grilling plate forming the top surface of said lower housing;
said upper grilling plate including a plurality of slider burger sized depressions;
said lower grilling plate including a plurality of raised slider burger placement disks that correspond to the location of said upper grilling plate burger depressions;
said lower grilling plate angled with regard to the ground plane;
said lower grilling plate including grease transporting channels;
said lower grilling plate including at least one drain aperture; and
said grease receiving tray slidably retained under said lower grilling plate and capable of retaining said grease that drips down from said lower grilling plate drain aperture.

2. Slider grilling appliance as claimed in claim 1 wherein said depressions in said upper grilling plate include raised bars that imprint said slider burger with grill markings similar to those found in a burger that is cooked on a standard outdoor grill.

3. Slider grilling appliance as claimed in claim 1 wherein said lower grilling plate placement disks each include a centrally located depression that helps hold said uncooked slider burger in the ideal location in relationship to the said burger depressions located on said top grilling plate.

4. Slider grilling appliance as claimed in claim 1 further comprising a spatula and burger forming tool wherein said tool includes, at one end, a depressed portion that is the size of a standard slider type burger, and on the opposite end, a spatula for removing said slider burgers from said grilling appliance.

5. Slider grilling appliance as claimed in claim 4 wherein said depressed portion of said spatula includes a centrally located aperture that allows a user to push said burger out of said depression.

6. Slider grilling appliance as claimed in claim 1 wherein said grilling plates are constructed of die cast aluminum and coated with a standard non stick coating.

7. Slider grilling appliance as claimed in claim 1 wherein when said slider burgers are finished cooking and said upper heat plate is lifted by the user, said slider burgers remain on said lower heat plate and can be easily removed by a standard spatula tool.
